(19) United States
(12) Patent Application Publication
(10) Pub. No.: US 2024/0233716 A1
(43) Pub. Date: Jul. 11, 2024

(54) ELECTRONIC DEVICE AND METHOD OF PROCESSING RESPONSE TO USER OF ELECTRONIC DEVICE

(71) Applicant: SAMSUNG ELECTRONICS CO., LTD., Suwon-si (KR)

(72) Inventors: Jisun CHOI, Suwon-si (KR); Kyungtae Kim, Suwon-si (KR); Gajin Song, Suwon-si (KR)

(73) Assignee: SAMSUNG ELECTRONICS CO., LTD., Suwon-si (KR)

(21) Appl. No.: 18/614,038

(22) Filed: Mar. 22, 2024

Related U.S. Application Data
(63) Continuation of application No. PCT/KR23/12591, filed on Aug. 24, 2023.

(30) Foreign Application Priority Data
Aug. 26, 2022 (KR) 10-2022-0107391
Sep. 27, 2022 (KR) 10-2022-0122580

(51) Int. Cl. G10L 15/18; G10L 15/22; G10L 15/30

(52) U.S. Cl. CPC G10L 15/1815; G10L 15/22; G10L 15/30

(57) ABSTRACT

Disclosed are an electronic device and a response processing method for a user of the electronic device. The electronic device includes a processor and a memory storing instructions. When the instructions are executed by the processor, the instructions may cause the electronic device to receive a user input. When the instructions are executed by the processor, the instructions may cause the electronic device to extract a first intent, a second intent, and a third intent from user input in order of reception of utterances. When the instructions are executed by the processor, the instructions may cause the electronic device to output a first response, a second response, and a third response respectively corresponding to the first intent, the second intent, and the third intent by arranging the response in a different order from the order of reception of utterances based on respective domains of the first intent, the second intent, and the third intent.

### CROSS-REFERENCE TO RELATED APPLICATIONS

This application is a continuation application of International Application No. PCT/KR2023/012591 designating the United States, filed on Aug. 24, 2023, in the Korean Intellectual Property Receiving Office and claiming priority to Korean Patent Application No. 10-2022-0107391, filed on Aug. 26, 2022, in the Korean Intellectual Property Office, and to Korean Patent Application No. 10-2022-0122580, filed on Sep. 27, 2022, in the Korean Intellectual Property Office, the disclosures of all of which are incorporated by reference herein in their entireties.

### BACKGROUND

### 1. Field

The disclosure relates to an electronic device and a response processing method for a user of the electronic device.

### 2. Description of Related Art

Voice assistants directly recognize user utterances, identify the intents and domains of the user utterances in the natural language understanding process and provide responses suitable for the intents of the user utterances.

Conventional voice assistants operate their mechanisms by identifying an intent of a user and producing a response to the intent in a one-to-one proportion. In other words, the conventional voice assistants provide one response to one user utterance.

### SUMMARY

According to an embodiment, an electronic device may include a processor and a memory storing instructions. When the instructions are executed by the processor, the instructions may cause the electronic device to receive a user input. When the instructions are executed by the processor, the instructions may cause the electronic device to extract a first intent, a second intent, and a third intent from the user input in order of reception of utterances. When the instructions are executed by the processor, the instructions may cause the electronic device to output a first response, a second response, and a third response respectively corresponding to the first intent, the second intent, and the third intent by arranging the responses in a different order from the order of reception of utterances based on domains of the first intent, the second intent, and the third intent.

According to an embodiment, an electronic device may include a processor and a memory storing instructions. When the instructions are executed by the processor, the instructions may cause the electronic device to receive a user input. When the instructions are executed by the processor, the instructions may cause the electronic device to extract a first intent, a second intent, and a third intent from the user input in order of reception of utterances. When the instructions are executed by the processor, the instructions may cause the electronic device to output a first response, a second response, and a third response respectively corresponding to the first intent, the second intent, and the third intent by grouping the responses in a different order from the order of reception of utterances based on domain information for rearranging an output order of responses.

According to an embodiment, a method of operating an electronic device may include receiving a user input. The method may include extracting a plurality of intents from the user input in order of reception of utterances. The method may include outputting a plurality of responses corresponding to the plurality of intents in a different order from the order of reception of utterances.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device 101 in a network environment 100 according to an embodiment;

FIG. 2 is a block diagram illustrating an integrated intelligence system according to an embodiment;

FIG. 3 is a diagram illustrating a form in which relationship information between concepts and actions is stored in a database according to an embodiment;

FIG. 4 is a diagram illustrating a screen of an electronic device processing a received speech input through an intelligent app according to an embodiment;

FIG. 5 is a block diagram illustrating an electronic device for performing response processing according to an embodiment;

FIG. 6A illustrates intents and domains arranged in an order in which inputs are received according to an embodiment;

FIG. 6B illustrates intents and domains of which an order is rearranged according to an embodiment;

FIG. 7 is a flowchart of an operation of an electronic device to rearrange an order of responses according to an embodiment;

FIG. 8 illustrates an example of a rearrangement of an order of responses according to an embodiment;

FIG. 9A illustrates an example in which an order of responses is not rearranged according to an embodiment;

FIG. 9B illustrates an example in which an order of responses is rearranged according to an embodiment;

FIG. 10 is a flowchart of an operation of rearranging an order of responses according to an embodiment;

FIG. 11 illustrates an example of a response rearrangement scenario according to an embodiment;

FIG. 12 illustrates an example of a user interface according to an embodiment;

FIGS. 13A and 13B illustrate examples of a user interface according to an embodiment; and

FIG. 14 is a flowchart of an operation of an electronic device according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

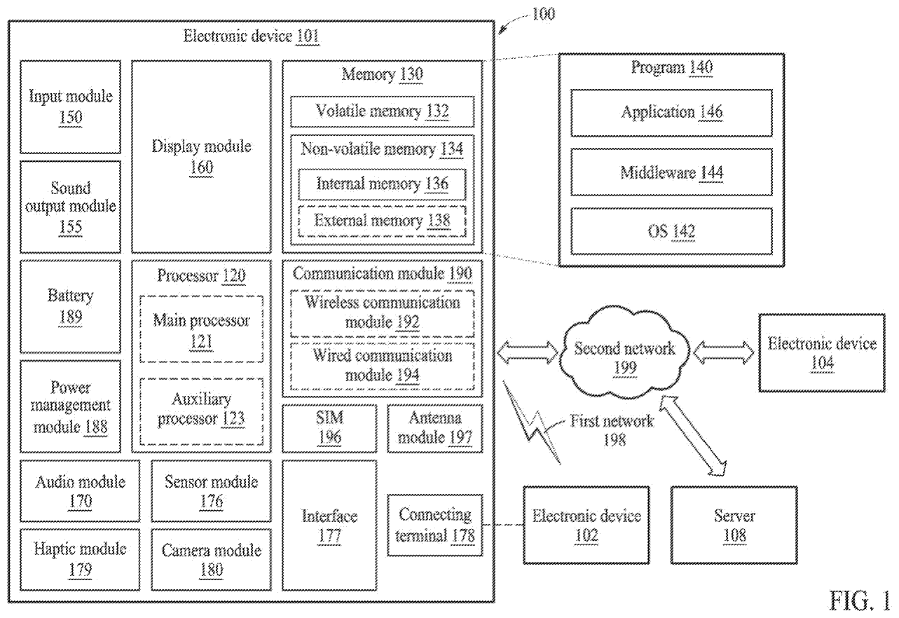

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated through machine learning. Such learning may be performed by, for example, the electronic device 101 in which AI is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch.

The audio module 170 may convert a sound into an electric signal and vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices (e.g., the electronic device 102 or 104) may be a device of the same type as or a different type from the electronic device 101. According to an embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

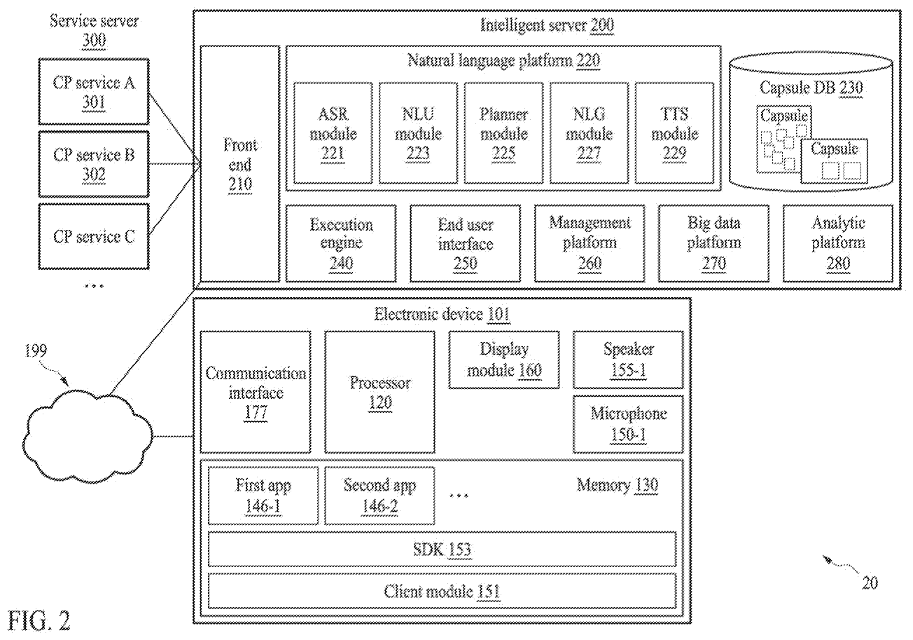

FIG. 2 is a block diagram illustrating an integrated intelligence system according to an embodiment.

Referring to FIG. 2, an integrated intelligence system 20 according to an embodiment may include an electronic device (e.g., the electronic device 101 of FIG. 1), an intelligent server 200 (e.g., the server 108 of FIG. 1), and a service server 300 (e.g., the server 108 of FIG. 1).

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the shown embodiment, the electronic device 101 may include a communication interface 177 (e.g., the interface 177 of FIG. 1), a microphone 150-1 (e.g., the input module 150 of FIG. 1), a speaker 155-1 (e.g., the sound output module 155 of FIG. 1), a display module 160 (e.g., the display module 160 of FIG. 1), a memory 130 (e.g., the memory 130 of FIG. 1), or a processor 120 (e.g., the processor 120 of FIG. 1). The components listed above may be operatively or electrically connected to each other.

The communication interface 177 may be connected to an external device and configured to transmit and receive data to and from the external device. The microphone 150-1 may receive a sound (e.g., a user utterance) and convert the sound into an electrical signal. The speaker 155-1 may output the electrical signal as a sound (e.g., a speech).

The display module 160 may be configured to display an image or video. The display module 160 may also display a graphical user interface (GUI) of an app (or an application program) being executed. The display module 160 may receive a touch input through a touch sensor. For example, the display module 160 may receive a text input through a touch sensor in an on-screen keyboard area displayed in the display module 160.

The memory 130 may store a client module 151, a software development kit (SDK) 153, and a plurality of apps 146 (e.g., the application 146 of FIG. 1). The client module 151 and the SDK 153 may configure a framework (or a solution program) for performing general-purpose functions. In addition, the client module 151 or the SDK 153 may configure a framework for processing a user input (e.g., a speech input, a text input, or a touch input).

The plurality of apps 146 stored in the memory 130 may be programs for performing designated functions. The plurality of apps 146 may include a first app 146_1, a second app 146_2, and the like. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the communication interface 177, the microphone 150-1, the speaker 155-1, and the display module 160 to perform a designated operation.

The processor 120 may also perform the designated function by executing the program stored in the memory 130. For example, the processor 120 may execute at least one of the client module 151 or the SDK 153 to perform the following operation for processing a user input. The processor 120 may control the actions of the plurality of apps 146 through, for example, the SDK 153. The following operation which is the operation of the client module 151 or the SDK 153 may be performed by the processor 120.

The client module 151 may receive a user input. For example, the client module 151 may receive a speech signal corresponding to a user utterance sensed through the microphone 150-1. As another example, the client module 151 may receive a touch input sensed through the display module 160. As still another example, the client module 151 may receive a text input sensed through a keyboard or an on-screen keyboard. In addition, the client module 151 may receive various types of user inputs sensed through an input module included in the electronic device 101 or an input module connected to the electronic device 101. The client module 151 may transmit the received user input to the intelligent server 200. The client module 151 may transmit state information of the electronic device 101 together with the received user input to the intelligent server 200. The state information may be, for example, execution state information of an app.

The client module 151 may receive a result corresponding to the received user input. For example, when the intelligent server 200 is capable of calculating a result corresponding to the received user input, the client module 151 may receive the result corresponding to the received user input. The client module 151 may display the received result on the display module 160. Further, the client module 151 may output the received result in an audio form through the speaker 155-1.

The client module 151 may receive a plan corresponding to the received user input. The client module 151 may display results of executing a plurality of actions of an app according to the plan on the display module 160. For example, the client module 151 may sequentially display the results of executing the plurality of actions on the display module 160 and output the results in an audio form through the speaker 155-1. As another example, the electronic device 101 may display only a portion of the results of executing the plurality of actions (e.g., a result of the last action) on the display module 160 and output the portion of the results in an audio form through the speaker 155-1.

According to an embodiment, the client module 151 may receive a request for obtaining information necessary for calculating a result corresponding to the user input from the intelligent server 200. According to an embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received user input has been correctly processed using the information on the results.

The client module 151 may include a speech recognition module. According to an embodiment, the client module 151 may recognize a speech input for performing a limited function through the speech recognition module. For example, the client module 151 may execute an intelligent app for processing a speech input to perform an organic operation through a designated input (e.g., Wake up!).

The intelligent server 200 may receive information related to a user's speech input from the electronic device 101 through a communication network. According to an embodiment, the intelligent server 200 may change data related to the received speech input into text data. According to an embodiment, the intelligent server 200 may generate a plan for performing a task corresponding to the user's speech input based on the text data.

According to an embodiment, the plan may be generated by an AI system. The AI system may be a rule-based system or a neural network-based system (e.g., a feedforward neural network (FNN) or a recurrent neural network (RNN)). Alternatively, the AI system may be a combination thereof or other AI systems. According to an embodiment, the plan may be selected from a set of predefined plans or may be generated in real time in response to a user request. For example, the AI system may select at least one plan from among the predefined plans.

The intelligent server 200 may transmit a result according to the generated plan to the electronic device 101 or transmit the generated plan to the electronic device 101. According to an embodiment, the electronic device 101 may display the result according to the plan on the display module 160. According to an embodiment, the electronic device 101 may display a result of executing an action according to the plan on the display module 160.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received user input from the electronic device 101. The front end 210 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the speech input received from the electronic device 101 into text data. The NLU module 223 may discern an intent of a user using the text data of the speech input. For example, the NLU module 223 may discern the intent of the user by performing syntactic analysis or semantic analysis on a user input in the form of text data. The NLU module 223 may discern the meaning of a word extracted from the user input using a linguistic feature (e.g., a grammatical element) of a morpheme or phrase, and determine the intent of the user by matching the discerned meaning of the word to an intent. The NLU module 223 may obtain intent information corresponding to the user utterance. The intent information may be information indicating an intention of the user determined through an analysis of the text data. The intent information may include information indicating an action or function that the user intends to execute using a device.

The planner module 225 may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment, some or all of the functions of the natural language platform 220 may be implemented in the electronic device 101 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a speech input. The strategy information may include reference information for determining one plan when there is a plurality of plans corresponding to the user input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information of information output through the electronic device 101. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an embodiment, the capsule DB 230 may be implemented in the electronic device 101 as well.

The execution engine 240 may calculate a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QOS) of the intelligent server 200. For example, the analytic platform 280 may manage the components and processing rate (or efficiency) of the intelligent server 200.

The service server 300 may provide a designated service (e.g., food order or hotel reservation) to the electronic device 101. According to an embodiment, the service server 300 may be a server operated by a third party. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the above-described integrated intelligence system 20, the electronic device 101 may provide various intelligent services to the user in response to a user input. The user input may include, for example, an input through a physical button, a touch input, or a speech input.

In an embodiment, the electronic device 101 may provide a speech recognition service through an intelligent app (or a speech recognition app) stored therein. In this case, for example, the electronic device 101 may recognize a user utterance or a speech input received through the microphone, and provide a service corresponding to the recognized speech input to the user.

In an embodiment, the electronic device 101 may perform a designated action alone or together with the intelligent server and/or a service server, based on the received speech input. For example, the electronic device 101 may execute an app corresponding to the received speech input and perform a designated action through the executed app.

In an embodiment, when the electronic device 101 provides a service together with the intelligent server 200 and/or the service server, the electronic device 101 may detect a user utterance using the microphone 150-1 and generate a signal (or speech data) corresponding to the detected user utterance. The electronic device 101 may transmit the speech data to the intelligent server 200 using the communication interface 177.

The intelligent server 200 may generate, as a response to the speech input received from the electronic device 101, a plan for performing a task corresponding to the speech input or a result of performing an action according to the plan. The plan may include, for example, a plurality of actions for performing a task corresponding to a speech input of a user, and a plurality of concepts related to the plurality of actions. The concepts may define parameters input to the execution of the plurality of actions or result values output by the execution of the plurality of actions. The plan may include connection information on connections between the plurality of actions and the plurality of concepts.

The electronic device 101 may receive the response using the communication interface 177. The electronic device 101 may output a speech signal internally generated by the electronic device 101 to the outside using the speaker 155-1, or output an image internally generated by the electronic device 101 to the outside using the display module 160.

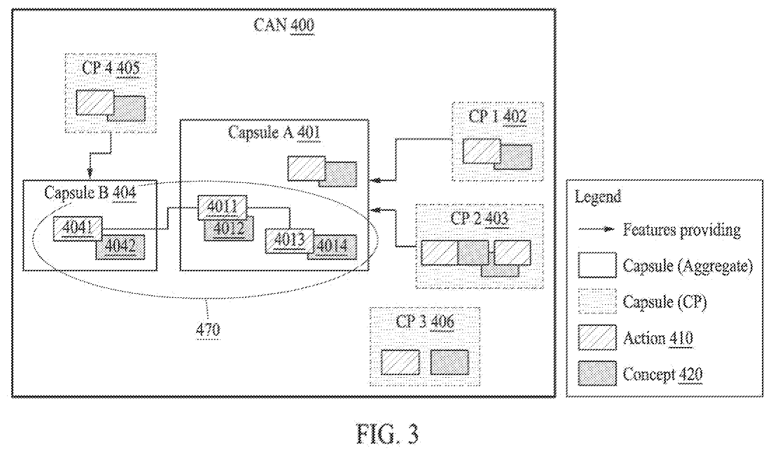

FIG. 3 is a diagram illustrating a form in which relationship information on relationships between concepts and actions is stored in a DB according to an embodiment.

A capsule DB (e.g., the capsule DB 230 of FIG. 2) of the intelligent server (e.g., the intelligent server 200 of FIG. 2) may store capsules in the form of a CAN 400. The capsule DB may store an action for processing a task corresponding to a speech input of a user and a parameter required for the action in the form of a CAN.

The capsule DB may store a plurality of capsules (a capsule A 401 and a capsule B 404) respectively corresponding to a plurality of domains (e.g., applications). According to an embodiment, one capsule (e.g., the capsule A 401) may correspond to one domain (e.g., a location (geo) or an application). Further, the one capsule may correspond to at least one service provider (e.g., CP 1 402 or CP 2 403) for performing a function for a domain related to the capsule. According to an embodiment, one capsule may include at least one action 410 for performing a designated function and at least one concept 420.

A natural language platform (e.g., the natural language platform 220 of FIG. 2) may generate a plan for performing a task corresponding to the received speech input using the capsules stored in the capsule DB. For example, a planner module (e.g., the planner module 225 of FIG. 2) of the natural language platform may generate the plan using the capsules stored in the capsule DB. For example, a plan 407 may be generated using actions 4011 and 4013 and concepts 4012 and 4014 of the capsule A 401 and an action 4041 and a concept 4042 of the capsule B 404.

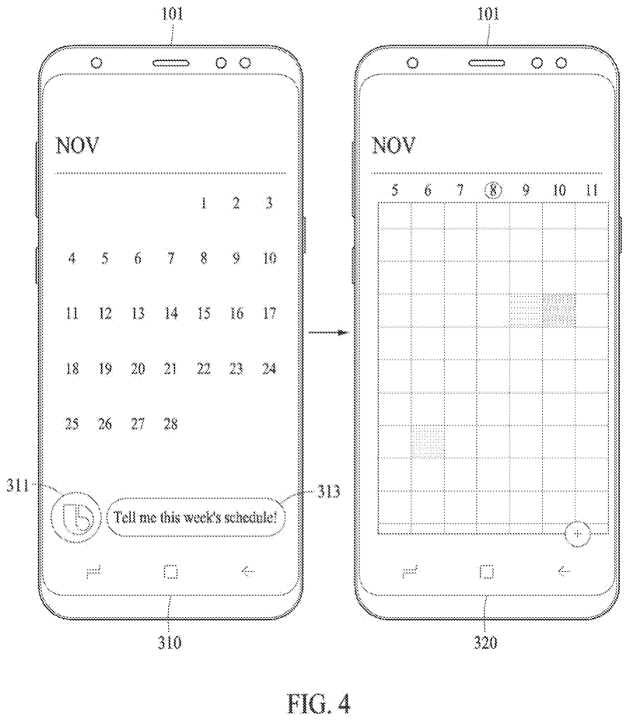

FIG. 4 is a diagram illustrating a screen of an electronic device processing a received speech input through an intelligent app according to an embodiment.

An electronic device (e.g., the electronic device 101 of FIG. 1) may execute an intelligent app to process a user input through an intelligent server (e.g., the intelligent server 200 of FIG. 2).

According to an embodiment, on a screen 310, when a designated speech input (e.g., Wake up!) is recognized or an input entered through a hardware key (e.g., a dedicated hardware key) is received, the electronic device 101 may execute an intelligent app for processing the speech input. The electronic device 101 may execute the intelligent app, for example, in a state in which a scheduling app is executed. According to an embodiment, the electronic device 101 may display an object (e.g., an icon) 311 corresponding to the intelligent app on a display module (e.g., the display module 160 of FIGS. 1 and 2). According to an embodiment, the electronic device 101 may receive a speech input by a user utterance. For example, the electronic device 101 may receive a speech input of “Tell me this week's schedule!”. According to an embodiment, the electronic device 101 may display a user interface (UI) 313 (e.g., an input window) of the intelligent app in which text data of the received speech input is displayed on the display module 160.

According to an embodiment, on a screen 320, the electronic device 101 may display a result corresponding to the received speech input on the display module 160. For example, the electronic device 101 may receive a plan corresponding to the received user input, and display “this week's schedule” on the display module 160 according to the plan.

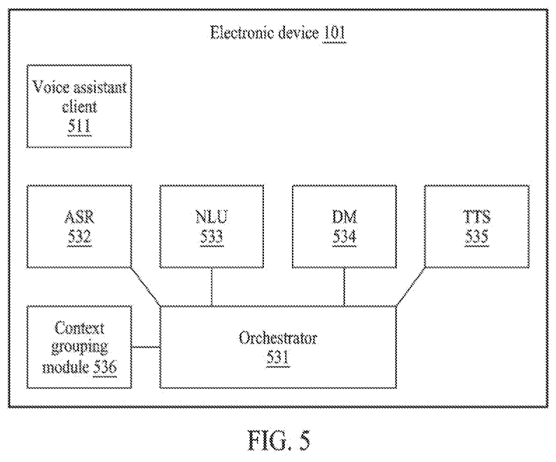

FIG. 5 is a block diagram illustrating an electronic device for performing response processing according to an embodiment.

Referring to FIG. 5, according to an embodiment, when the electronic device 101 needs to provide a plurality of responses to a user in a multi-intent situation, the electronic device 101 may efficiently provide the plurality of responses by rearranging an order of the plurality of responses.

According to an embodiment, the electronic device 101 may generate a text input by receiving an input (e.g., a text input and/or a speech signal) from the user. The electronic device 101 may extract intents corresponding to a text input obtained by converting the text input or speech signal received from the user and may prevent intents, among the extracted intents, in domains of similar characteristics from being sporadically responded to.

According to an embodiment, the electronic device 101 may output responses respectively corresponding to the intents of the user by arranging the responses in a different order from the order of reception of utterances based on domain information for rearranging an output order of responses. The domain information may include a combination of one or more of a first domain list (e.g., a predefined context grouping domain) for rearranging the output order of responses, a second domain list (e.g., a predefined domain block list) for preventing the output order of responses from being rearranged, and a priority. The first domain list may include one or more domains for rearranging the output order of responses. The second domain list may include one or more domains for preventing the output order of responses from being rearranged.

According to an embodiment, the electronic device 101 may group and provide responses of intents classified into the same domain among the intents of the user and group and provide responses corresponding to domains included in the first domain list that are not the same. In addition, the electronic device 101 may rearrange the output order of responses grouped based on priority. By grouping the responses, the electronic device 101 may help the user listen to responses and understand sentences in a conversation that flows naturally while maintaining its context.

According to an embodiment, when a grouping condition is satisfied, the electronic device 101 may rearrange the order of one or more responses. When a multi-intent input is received, the electronic device 101 may rearrange the order of responses differently from the order of reception of utterances by determining whether the domains of intents are included in the first domain list or the second domain list. The electronic device 101 may extract a first intent, a second intent, and a third intent from the user input in order of reception of utterances. The order of reception of utterances may correspond to the order of intent extraction. The electronic device 101 may identify a domain of each of the first intent, the second intent, and the third intent. The electronic device 101 may output a first response, a second response, and a third response respectively corresponding to the first intent, the second intent, and the third intent by arranging the responses in a different order from the order of reception of utterances based on respective domains of the first intent, the second intent, and the third intent. The electronic device 101 may consecutively output the first response and the third response and output the second response later than a pair of the first response and the third response that are consecutively output. Only the domain of the first intent and the domain of the third intent may correspond to a domain (e.g., a domain included in the first domain list) for rearranging the output order of responses. The domain of the first intent and the domain of the third intent may be different from the domain of the second intent, and the domain of the first intent and the domain of the third intent may be different or the same. The electronic device 101 may group the first response and the third response into a first group and group the second response into a second group by determining whether the first intent, the second intent, and the third intent are included in the first domain list or the second domain list. The electronic device 101 may output the second group later than the first group. In addition, the electronic device 101 may rearrange the order of the first response and the third response in the first group based on priority. The third response may be output prior to the first response based on priority.

According to an embodiment, the electronic device 101 may include a voice assistant client 511, an orchestrator 531, an ASR module 532 (e.g., the ASR module 221 of FIG. 2), an NLU module 533 (e.g., the NLU module 223 of FIG. 2), a dialogue manager (DM) 534, a TTS module 535 (e.g., the TTS module 229 of FIG. 2), and a context grouping module 536.

According to an embodiment, at least one of the voice assistant client 511, the orchestrator 531, the ASR module 532, the NLU module 533, the DM 534, the TTS module 535, and the context grouping module 536 may be included in a processor (e.g., the processor 120 of FIG. 1).

According to an embodiment, at least one of the orchestrator 531, the ASR module 532, the NLU module 533, the DM 534, the TTS module 535, and the context grouping module 536 may be implemented in a server (e.g., the server 108 of FIG. 1 and the intelligent server 200 of FIG. 2) that performs communication with the electronic device 101.

According to an embodiment, the voice assistant client 511 may receive an utterance from the user. The electronic device 101 may include a microphone (e.g., the microphone 150-1 of FIG. 2) for receiving a user utterance, a speaker (e.g., the speaker 155-1 of FIG. 2), and an input device (e.g., a touch screen) into which a text is written. The voice assistant client 511 may perform an action generated in response to the user utterance and output a speech using TTS.

According to an embodiment, the orchestrator 531 may control the ASR module 532, the NLU module 533, the DM 534, the TTS module 535, and the context grouping module 536.

According to an embodiment, the ASR module 532 may receive a speech signal of the user. The ASR module 532 may convert the speech signal into a text input. The ASR module 532 may convert the user utterance input through the voice assistant client 511 into a text form that is processible by the NLU module 533. An utterance input to the ASR module 532 may include one or more sentences according to a user input.

According to an embodiment, the NLU module 533 may analyze the form of the text input through the ASR module 532. The NLU module 533 may receive the text input directly from the user without passing through the ASR module 532 depending on an embodiment.

According to an embodiment, the NLU module 533 may extract one or more intents and/or one or more performance parameters (e.g., slots) from the text input. The NLU module 533 may determine one or more responses based on the one or more intents and performance parameters. The NLU module 533 may understand and determine an intent of the user utterance. The NLU module 533 may classify intents that have a high similarity through utterance analysis. The NLU module 533 may determine a performance parameter through the utterance analysis.

According to an embodiment, the NLU module 533 may determine actions to be finally performed and responses to be output from the TTS module 535 by processing the utterance based on the intent and the performance parameter. The NLU module 533 may generate an output text to be output to the user based on the speech signal.

According to an embodiment, the NLU module 533 may extract the one or more intents and the one or more domains from the text input. The NLU module 533 may determine a plurality of domains matching a plurality of intents. When the utterance received from the ASR module 532 is an utterance having a plurality of intents, the NLU module 533 may extract a plurality of intents or a plurality of performance parameters. The NLU module 533 may detect the plurality of intents or the plurality of performance parameters based on an arbitrary algorithm. For example, the NLU module 533 may detect the plurality of intents or the plurality of performance parameters using a neural network.

According to an embodiment, the DM module 534 may maintain the context of a conversation between the user and the voice assistant. The DM module 534 may determine response information and/or an action to be provided to the user based on the intent obtained by the NLU module 533 and parameter information. The DM module 534 may include some or all of the functions performed by the planner module 225 and/or the NLG module 227 of the intelligent server 200 of FIG. 2.

According to an embodiment, the DM module 534 may generate a plurality of responses or unit responses based on the plurality of intents and the plurality of performance parameters determined by the NLU module 533. A response may include visual information, auditory information, and/or text information. The generated plurality of unit responses may be transmitted/provided to the user sequentially or in parallel. An order of the plurality of unit responses may be rearranged through the context grouping module 536 and provided to the user.

According to an embodiment, when the actions to be finally performed are determined, the TTS module 535 may convert text data, to be output to conform to the determined actions, into speech data. The TTS module 535 may receive the text data in a form of speech synthesis markup language (SSML), convert the text data into the speech data, and output the converted speech data.

According to an embodiment, the context grouping module 536 may determine whether a grouping condition of the one or more domains is satisfied based on domain information. The context grouping module 536 may determine an order of the one or more responses based on whether the grouping condition is satisfied.

According to an embodiment, the context grouping module 536 may group the one or more domains based on the first domain list or the second domain list. The context grouping module 536 may rearrange the order of the responses based on the grouped domains.

According to an embodiment, the context grouping module 536 may determine whether the grouping condition of the one or more domains is satisfied based on the first domain list or the second domain list. The context grouping module 536 may group the one or more domains based on the whether the grouping condition is satisfied.

According to an embodiment, the context grouping module 536 may determine whether the one or more domains are included in the first domain list or the second domain list. The context grouping module 536 may rearrange an order of one or more responses corresponding to the one or more domains based on a result of determining whether the one or more domains are included in the first domain list or the second domain list.

According to an embodiment, the context grouping module 536 may group responses corresponding to domains, which are included in the first domain list, into the first group. The context grouping module 536 may group responses corresponding to domains, which are not included in the first domain list, into the second group. The context grouping module 536 may determine the order of the first group and the second group. Similarly, the context grouping module 536 may group the responses into the first group and the second group using the second domain list and determine the order of the first group and the second group.

According to an embodiment, the context grouping module 536 may generate the first domain list or the second domain list based on a usage history of the user, a preference of the user for a response, or attributes of the one or more domains or an association among the one or more domains.

According to an embodiment, the context grouping module 536 may exclude some of the one or more domains based on the second domain list and extract the remaining domains. The context grouping module 536 may generate the first domain list (e.g., the predefined context grouping domain) based on the remaining domains.

According to an embodiment, the context grouping module 536 may assign priorities to the domains, which are included in the first domain list. The context grouping module 536 may determine the order of the responses based on the priorities. The priorities may be determined on an intent-by-intent or domain-by-domain basis.

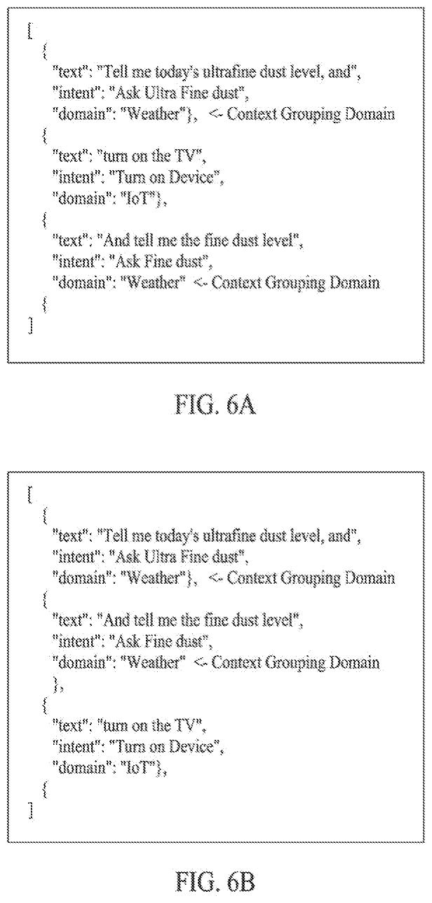

FIG. 6A illustrates intents and domains arranged in an order in which inputs are received according to an embodiment, and FIG. 6B illustrates intents and domains of which an order is rearranged according to an embodiment.

Referring to FIGS. 6A and 6B, according to an embodiment, when an ASR module (e.g., the ASR module 532 of FIG. 5) receives the utterance “Tell me today's ultrafine dust level, and turn on the TV. And tell me the fine dust level.” from a user or receives the same sentence as a text input from the user, an NLU module (e.g., the NLU module 533 of FIG. 5) may extract the first intent (e.g., “Ask Ultra Fine dust”), the second intent (e.g., “Turn on Device”), and the third intent (e.g., “Ask Fine dust”) from the user input (“Tell me today's ultrafine dust level, and turn on the TV. And tell me the fine dust level.”) in order of reception of utterances and classify the domain of the first intent as “Weather”, the domain of the second intent as “IoT”, and the domain of the third intent as “Weather”, as illustrated in FIG. 6A.

According to an embodiment, a context grouping module (e.g., the context grouping module 536 of FIG. 5) may provide a plurality of responses corresponding to multiple intents after rearranging an order of the responses. The context grouping module 536 may include matching information about the first domain list (e.g., the predefined context grouping domain). The context grouping module 536 may generate the first domain list. Alternatively, the first domain list may be defined by a manager of the context grouping module 536 in advance or defined by the user. For example, the first domain list may be provided as shown in Table 1.

TABLE 1
Context grouping domain

| | |
|---|---|
| 1 | Weather |
| 2 | Stock |
| 3 | Q&A |

According to an embodiment, when a text input including multiple intents is received from the user, domains, such as weather, stock, and Q&A domains may need to be considered to rearrange an order of responses.

According to an embodiment, text responses of domains other than the domains included in the first domain list shown in Table 1 may not be considered when rearranging the order of the responses. When rearranging the order of the responses and transmitting the responses by defining the first domain list, the context grouping module 536 may consider whether meaningful usability is provided to the user. The examples shown in Table 1 may be the first domain list obtained by considering domains that provide factual information to the user among domains with various attributes. As shown in Table 1, the context grouping module 536 may efficiently operate a response processing system by selecting domains having an attribute of a domain providing information as domains included in the first domain list.

According to an embodiment, as illustrated in FIG. 6A, among intents and domains identified by the NLU module 533, two intents, the first intent (e.g., “Ask Ultra Fine dust”) and the third intent (e.g., “Ask Fine dust”), correspond to the “weather” domain, and text inputs corresponding to the two intents may not be temporally consecutive text inputs. The context grouping module 536 may rearrange the order of actions or responses such that actions or responses, which are associated with each other or corresponding to the same domain, are output together. As illustrated in FIG. 6B, the context grouping module 536 may rearrange the order of actions or responses such that responses to the first intent (e.g., “Ask Ultra Fine dust”) and the third intent (e.g., “Ask Fine dust”) corresponding to the domain included in the first domain list are output together.

With reference to FIGS. 6A and 6B, the rearrangement of the response order using the first domain list is described for ease of description. However, embodiments are not limited thereto, and a response order may be rearranged using the second domain list depending on an embodiment.

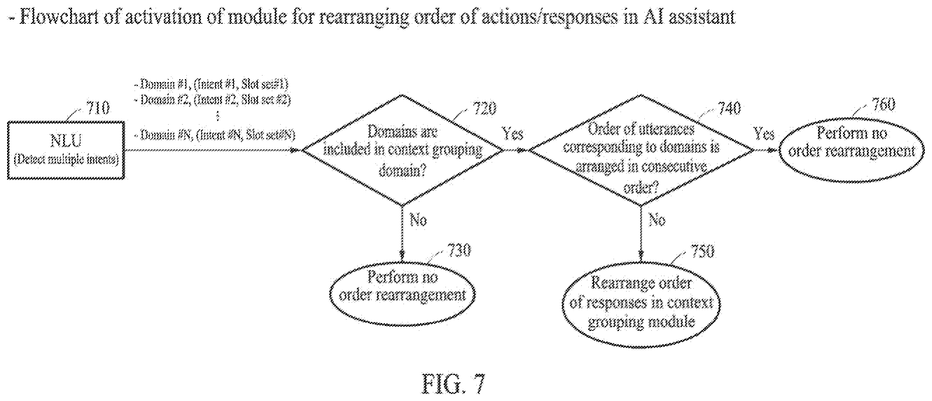

FIG. 7 is a flowchart of an operation of an electronic device to rearrange an order of responses according to an embodiment.

In the following embodiments, operations may be performed sequentially, but not necessarily sequentially. For example, the order of the operations may be changed, and at least two of the operations may be performed in parallel.

Referring to FIG. 7, according to an embodiment, when there are text inputs corresponding to domains, which are included in the first domain list, among text inputs received from a user, and when the text inputs corresponding to the domains, which are included in the first domain list, are received in a non-consecutive order (e.g., when the text inputs corresponding to the domains, which are included in the first domain list, are not received in a sequential order), a context grouping module (e.g., the context grouping module 536 of FIG. 5) may rearrange an order of actions or responses corresponding to the text inputs.

According to an embodiment, in operation 710, an NLU module (e.g., the NLU module 533 of FIG. 5) may detect one or more intents from text inputs received from an ASR module (e.g., the ASR module 532 of FIG. 5) or a user. The NLU module 533 may detect domains, intents, and performance parameters (e.g., slots) and output them to the context grouping module 536.

According to an embodiment, in operation 720, the context grouping module 536 may determine whether domains corresponding to the received text inputs are domains that are included in the first domain list. In operation 730, the context grouping module 536 may not perform order rearrangement when the domains are not included in the first domain list.

According to an embodiment, in operation 740, when the domains are included in the first domain list, the context grouping module 536 may determine whether the text inputs (or utterances) corresponding to the domains are arranged in a consecutive order. In operation 750, when the text inputs are arranged in a non-consecutive order, the context grouping module 536 may rearrange an order of responses. In operation 760, when the text inputs are arranged in the consecutive order, the context grouping module 536 may not rearrange the order of the responses.

With reference to FIG. 7, for ease of description, the operation in which the electronic device 101 rearranges the order of the responses using the first domain list. However, embodiments are not limited thereto, and the electronic device 101 may rearrange the order of the responses using the second domain list.

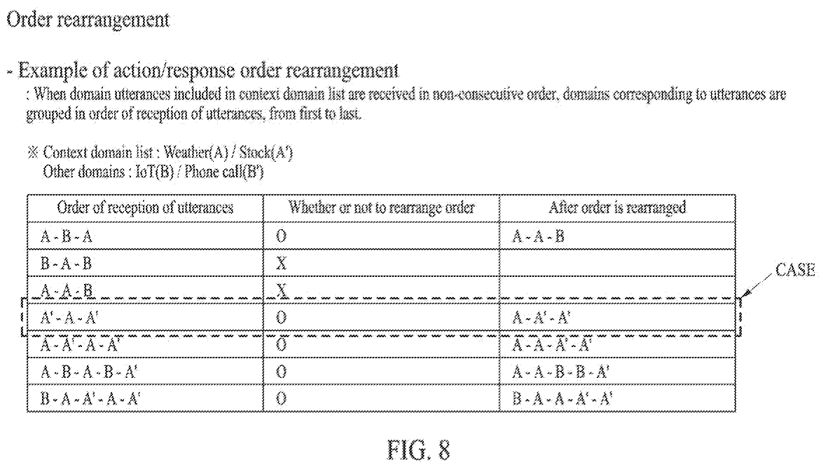

FIG. 8 illustrates an example of a rearrangement of an order of responses according to an embodiment.

Referring to FIG. 8, according to an embodiment, a context grouping module (e.g., the context grouping module 536 of FIG. 5) may rearrange an order of actions or responses corresponding to one or more domains based on an order arrangement algorithm. The context grouping module 536 may rearrange an order of actions or responses by searching text inputs in order from first to last or from last to first. FIG. 8 illustrates an example of an operation of rearranging an order of responses corresponding to the same domain by searching the text inputs in order from first to last. More particularly, FIG. 8 provides an example of rearranging an action/response order when domain utterances included in the first domain list are received in a non-sequential order. This example involves grouping domains corresponding to utterances in order of reception, from first to last.

According to an embodiment, the context grouping module 536 may exclude some of the one or more domains based on a second domain list and extract remaining domains. The context grouping module 536 may generate a first domain list based on the remaining domains.

According to an embodiment, the context grouping module 536 may manage domains by defining the second domain list including exceptional domains instead of managing the first domain list. The context grouping module 536 may set a system default such that basically all domains are grouped and may manage exceptional capsules that do not rearrange the output order of responses (or do not perform grouping) as the second domain list.

According to an embodiment, when selecting an Internet of Things (IOT) domain as the second domain list, the context grouping module 536 may operate by basically regarding all domains other than the IoT domain as a domain included in the first domain list. When there is no additional second domain list, the context grouping module 536 does not need to match and compare a second domain list with the first domain list, so the execution time may be reduced. In addition, when the number of second domain lists is limited, the context grouping module 536 may reduce the time required to compare second domain lists with the first domain list.

According to an embodiment, the context grouping module 536 may assign priorities to domains, which are included in the first domain list. The context grouping module 536 may determine an order of responses based on the priorities.

According to an embodiment, the context grouping module 536 may set priorities among domains included in the first domain list and define a domain or action having a priority in advance. When it is identified that a domain or action having a predetermined priority is included in a multi-intent utterance, the context grouping module 536 may assign a priority to an identified intent utterance that has a predetermined priority, enabling an action or a response to be provided to the identified intent utterance before being provided to intents of other utterances. In addition, the context grouping module 536 may establish priorities according to a predetermined intent (e.g., a request for current temperature information) as well as a domain.

An example in which an order of responses is rearranged is described with reference to CASE shown in FIG. 8. For ease of description, it is assumed that the IoT domain is selected as the second domain list and that domains other than the IoT domain are basically regarded as the first domain list. In addition, when a weather domain and a stock domain are included in the first domain list, it is assumed that the weather domain is P1 (priority 1) and the stock domain is P2 (priority 2). In CASE shown in FIG. 8, when a user utters “Tell me today's KOSPI index (stock A′), and tell me today's temperature (weather A). And tell me the KOSDAQ index (stock A′),” the context grouping module 536 may adjust an order of responses such that a response (e.g., a response to weather A) to the weather domain having a higher priority is produced first and may output the response to the weather domain first and a response to the stock domain later.

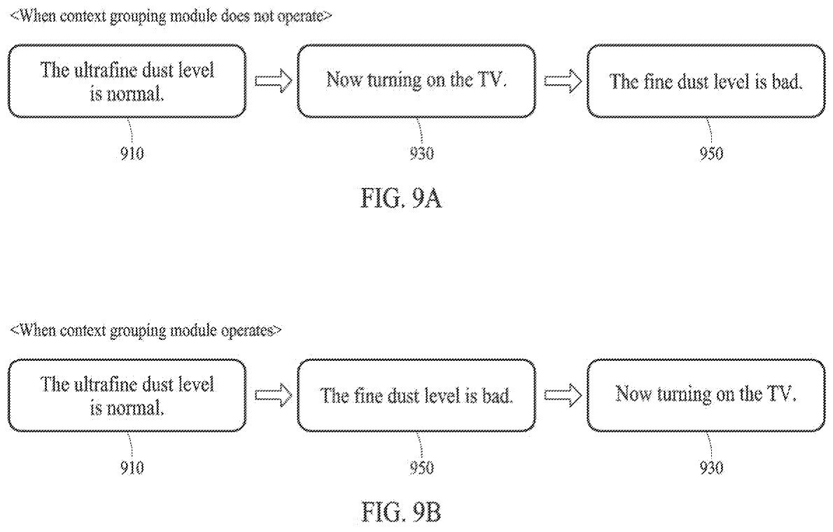

FIG. 9A illustrates an example (e.g., an example in which a context grouping module is not in operation) in which an order of responses is not rearranged according to a comparative embodiment, and FIG. 9B illustrates an example (e.g., an example in which a context grouping module is in operation) in which an order of responses is rearranged according to an embodiment.

Referring to FIGS. 9A and 9B, according to an embodiment, a DM module (e.g., the DM module 534 of FIG. 5) may rearrange an order of actions and an order of responses simultaneously or in parallel depending on an order defined by a context grouping module (e.g., the context grouping module 536 of FIG. 5). Alternatively, according to an embodiment, the DM module 534 may rearrange the order of actions or the order of responses but not both.

According to an embodiment, FIG. 9B illustrates an example in which actions may be generated sequentially along with responses, a response related to a TV may be provided last, and an action for turning on the TV may be performed. However, the DM module 534 may transmit the responses in an order rearranged by the context grouping module 536 and allow the actions to be performed in an order of user utterances. In other words, the action for turning on the TV may be performed second, but a response informing that the TV is turned on may be adjusted when all responses are transmitted such that the response is output last.

According to an embodiment, when a plurality of responses of the same domain is grouped or rearranged, the DM module 534 may additionally modify the plurality of responses and output the modified responses. For example, referring to FIG. 9B, a response 910 and a response 950 may be merged into one response, and thus, a response “The ultrafine dust level is normal, and the fine dust level is bad” may be output. The merged response may be synthesized into a speech signal through TTS and provided to a user. According to an embodiment, a natural language analysis operation or a natural language generation operation may be performed on a plurality of response texts to perform an operation of merging responses.

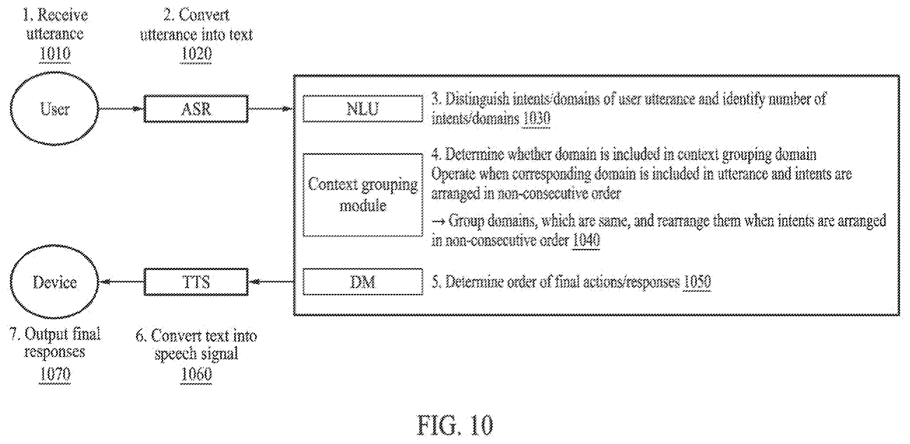

FIG. 10 is a flowchart of an operation of rearranging an order of responses according to an embodiment.

In the following embodiments, operations may be performed sequentially, but not necessarily sequentially. For example, the order of the operations may be changed, and at least two of the operations may be performed in parallel.

Referring to FIG. 10, according to an embodiment, in operation 1010, an ASR module (e.g., the ASR module 532 of FIG. 5) may receive an utterance from a user. In operation 1020, the ASR module 532 may convert the utterance from the user into a text.

According to an embodiment, an NLU module (e.g., the NLU module 533 of FIG. 5) may identify intents and domains of the utterance from the user. When an utterance including multiple intents is received, the NLU module 533 may distinguish all intents and domains.

According to an embodiment, a context grouping module (e.g., the context grouping module 536 of FIG. 5) may search for whether a domain to which actions or responses are grouped is included in a multi-intent situation using a first domain list (e.g., a predefined context grouping domain). In operation 1040, when domains corresponding to the utterance from the user are included in the first domain list and the intents are arranged in a non-consecutive order (e.g., when the intents corresponding to the domains, which are included in the first domain list, are not arranged in a sequential order), the context grouping module 536 may group domains, which are the same or associated with each other, and rearrange them. The context grouping module 536 may rearrange domains to be grouped in an order in which the domains to be grouped need to be processed by a DM module (e.g., the DM module 534 of FIG. 5).

According to an embodiment, in operation 1050, the DM module 534 may determine actions to be finally performed or responses to be finally output. The DM module 534 may determine content or an order of the actions to be finally performed and the responses to be finally output according to an order changed by the context grouping module 536.

According to an embodiment, in operation 1060, a TTS module (e.g., the TTS module 535 of FIG. 5) may convert the final response defined as text into SSML before a speech synthesis operation by TTS is performed, such that the final response is output in a form of speech. In operation 1070, a device (e.g., the electronic device 101 of FIG. 5) may perform the final action and output a response.

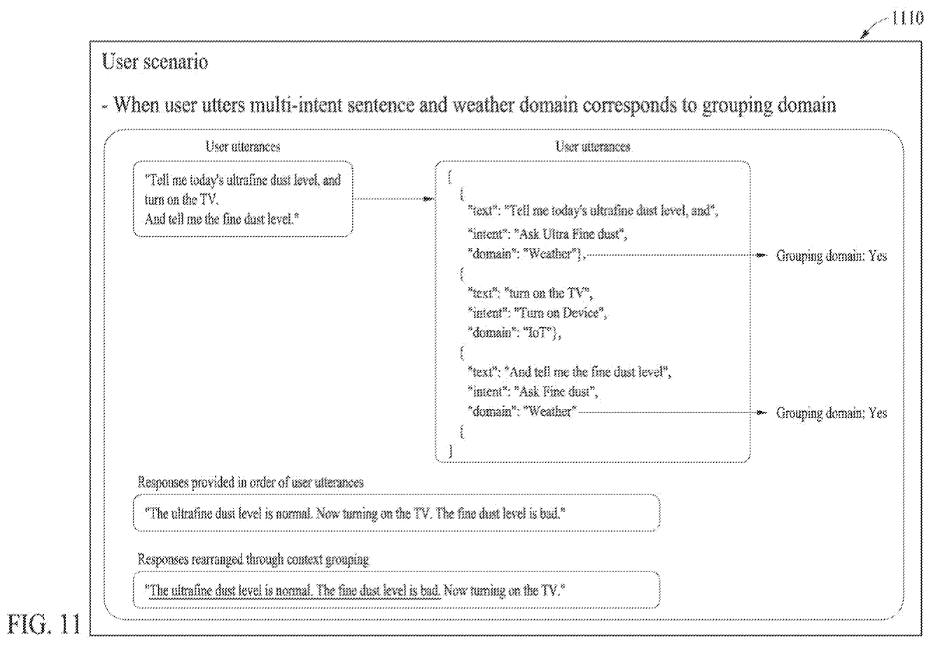

FIG. 11 illustrates an example of a response rearrangement scenario according to an embodiment.

A response rearrangement scenario 1110 illustrated in FIG. 11 may be an example in which a user utters the multi-intent sentence “Tell me today's ultrafine dust level, and turn on the TV. And tell me the fine dust level.” In the response rearrangement scenario 1110, it is assumed that domains corresponding to a weather domain are domains to be grouped included in a first domain list. An NLU module may extract a first intent (e.g., “Ask Ultra Fine dust”), a second intent (e.g., “Turn on Device”), and a third intent (e.g., Ask Fine dust”) from the sentence” Tell me today's ultrafine dust level, and turn on the TV. And tell me the fine dust level” in order of reception of utterances and categorize the domain of the first intent as “Weather”, the domain of the second intent as “IoT”, and the domain of the third intent as “Weather”. A context grouping module (e.g., the context grouping module 536 of FIG. 5) may identify that the domain of the first intent and the domain of the third intent are to be grouped into the weather domain and that the second intent, which has a different domain, is arranged between the first intent and the third intent and may rearrange responses to respective sentences. The context grouping module (e.g., the context grouping module 536 of FIG. 5) may rearrange the responses “The ultrafine dust level is normal. Now turning on the TV. The fine dust level is bad,” which are in accordance with an order of reception of utterances (or an order of user utterances), and provide responses “The ultrafine dust level is normal. The fine dust level is bad. Now turning on the TV.” For example, a first response (e.g., “The ultrafine dust level is normal”) of the first intent, a second response (e.g., “Now turning on the TV”) of the second intent, and a third response (e.g., “The fine dust level is bad”) of the third intent may be provided differently from the order of reception of utterances.

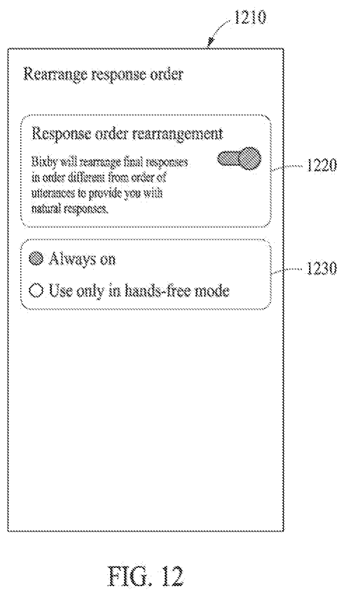

FIG. 12 illustrates an example of a user interface according to an embodiment.

Referring to FIG. 12, according to an embodiment, a processor (e.g., the processor 120 of FIG. 1) may provide a user interface 1210. The user interface 1210 may include a first user interface 1220 and a second user interface 1230. The first user interface 1220 may be a user interface for a user to turn on or off a response rearrangement function for rearranging an order of responses. The second user interface 1230 may be a user interface for the user to select an operation mode of the response rearrangement function in a state in which the response rearrangement function is turned on (e.g., activated). The response rearrangement function may be operated in a first mode (e.g., “Always on” mode) or a second mode (e.g., “Use only in hands-free mode” mode). In the first mode, the response rearrangement function may be performed regardless of an environment in which an electronic device (e.g., the electronic device 101 of FIG. 5) is used. In the second mode, the response rearrangement function may be performed in a hands-free mode in which the electronic device 101 is connected (e.g., connected through Bluetooth) to an external electronic device (e.g., a wireless audio device and a vehicle).

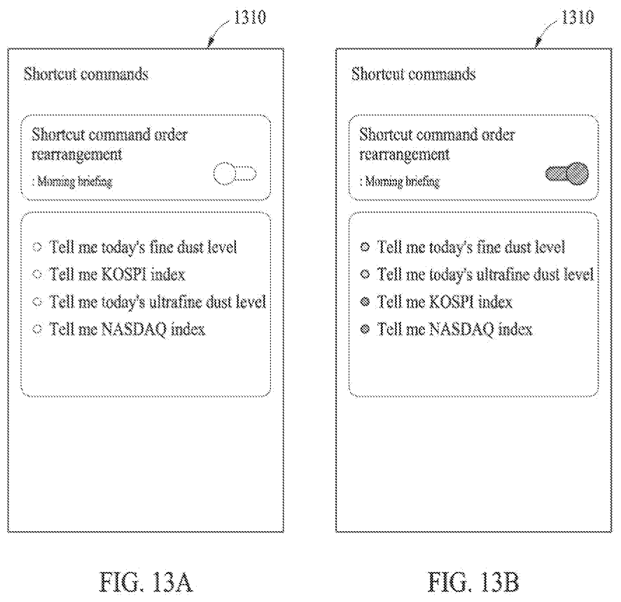

FIGS. 13A and 13B illustrate examples of a user interface according to an embodiment.

Referring to FIGS. 13A and 13B, according to an embodiment, a processor (e.g., the processor 120 of FIG. 1) may provide a user interface 1310. The user interface 1310 may be used to rearrange an order of actions or responses having the same domain using a context grouping module (e.g., the context grouping module 536 of FIG. 5) even when using a shortcut command function for performing operations consecutively. Through the user interface 1310, a user may turn on (e.g., activate) or turn off (e.g., deactivate) a rearrangement function of the shortcut command function used to arrange an order of actions or an order of responses. The shortcut command function may be a function for performing a plurality of command sentences (e.g., “Tell me today's fine dust level,” “Tell me today's ultrafine dust level,” and “Tell me the KOSPI index”) sequentially or in parallel through an electronic device (e.g., the electronic device 101 of FIG. 5) or an intelligent server (e.g., the intelligent server 200 of FIG. 2) when a shortcut command (e.g., “Morning briefing”) set by the user is input in a form of a user utterance or text. The user may write his or her own shortcut commands and a plurality of command sentences to use the shortcut command function.

FIG. 13A illustrates an example in which the rearrangement function of the shortcut command function is turned off, and FIG. 13B illustrates an example in which the rearrangement function of the shortcut command function is turned on. As illustrated in FIG. 13B, an order of a plurality of command sentences may be changed according to a changed order, and the sentences may be displayed on a screen. Alternatively, when a function in response to a shortcut command is performed, an order in which the plurality of command sentences is performed may be changed, and a response may be provided.

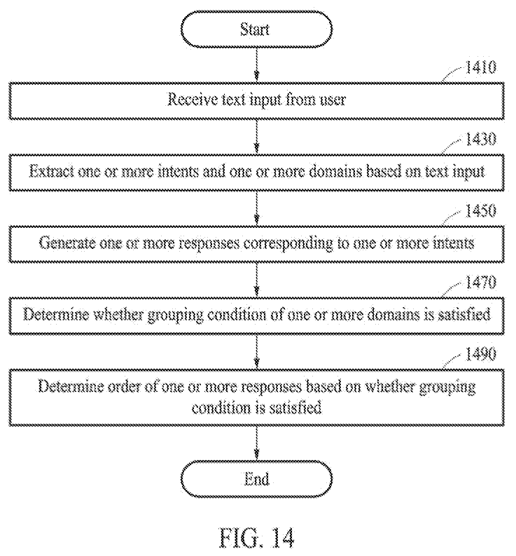

FIG. 14 is a flowchart of an operation of an electronic device according to an embodiment.

In the following embodiments, operations may be performed sequentially, but not necessarily sequentially. For example, the order of the operations may be changed, and at least two of the operations may be performed in parallel.

According to an embodiment, it may be understood that operations 1410 to 1490 may be performed by a processor (e.g., the processor 120 of FIG. 1) of an electronic device (e.g., the electronic device 101 of FIG. 1).

Referring to FIG. 14, according to an embodiment, the electronic device (e.g., the electronic device 101 of FIG. 1) for processing a response to a user may include the processor (e.g., the processor 120 of FIG. 1) and a memory (e.g., the memory 130 of FIG. 1) configured to store instructions to be executed by the processor.

According to an embodiment, in operation 1410, the processor 120 may receive a text input. The text input may be directly received from a user or input after a user utterance is converted into a text. In operation 1430, the processor 120 may extract one or more intents and one or more domains from the text input. The processor 120 may receive the text input from the user. Alternatively, the processor 120 may generate the text input by converting a speech signal received from the user.

According to an embodiment, in operation 1450, the processor 120 may generate one or more responses corresponding to the one or more intents. The processor 120 may extract one or more intents and a performance parameter from the text input. The processor 120 may determine one or more responses based on the one or more intents and the performance parameter.

According to an embodiment, in operation 1470, the processor 120 may determine whether a grouping condition of the one or more domains is satisfied. According to an embodiment, the processor 120 may determine whether the grouping condition of the one or more domains is satisfied based on a first domain list (e.g., a predefined context grouping domain) or a second domain list (e.g., a predefined domain block list).

According to an embodiment, in operation 1490, the processor 120 may determine an order of the one or more responses based on whether the grouping condition is satisfied. The processor 120 may determine whether the one or more domains are included in the first domain list or the second domain list. The processor 120 may rearrange the order of the one or more responses corresponding to the one or more domains based on whether the domains are included in the context grouping domain.

According to an embodiment, the processor 120 may group responses corresponding to domains, which are included in the first domain list, into a first group. The processor 120 may group responses corresponding to domains, which are not included in the first domain list, into a second group. The processor 120 may determine an order of the first group and the second group.

According to an embodiment, the processor 120 may generate the first domain list and/or the second domain list based on a usage history of the user, a preference of the user for a response, or attributes of the one or more domains or an association among the one or more domains.

According to an embodiment, the processor 120 may exclude some domains of the one or more domains based on the second domain list and extract remaining domains. The processor 120 may generate the first domain list based on the remaining domains.

According to an embodiment, the processor 120 may assign priorities to the domains, which are included in the first domain list. The processor 120 may determine an order of the responses based on the priorities.

According to an embodiment, an electronic device 101 may include a processor 120 and a memory 130 storing instructions. When the instructions are executed by the processor 120, the instructions may cause the electronic device 101 to receive a user input. When the instructions are executed by the processor 120, the instructions may cause the electronic device 101 to extract a first intent, a second intent, and a third intent from the user input in order of reception of utterances. When the instructions are executed by the processor 120, the instructions may cause the electronic device 101 to output a first response, a second response, and a third response respectively corresponding to the first intent, the second intent, and the third intent by arranging the responses in a different order from the order of reception of utterances based on domains of the first intent, the second intent, and the third intent.

According to an embodiment, the instructions may further cause the electronic device 101 to group the first response and the third response into a first group and group the second response into a second group by determining whether the domains of the first intent, the second intent, and the third intent are included in a first domain list or a second domain list. The first domain list may include one or more domains for rearranging an output order of responses. The second domain list may include one or more domains for preventing an output order of responses from being rearranged.

According to an embodiment, the instructions may further cause the electronic device 101 to rearrange an order of the first response and the third response in the first group based on a priority.

According to an embodiment, the first domain list or the second domain list may be based on a usage history of a user, a user response preference, or an attribute of a domain or an association among domains.

According to an embodiment, the instructions may cause the electronic device 101 to consecutively output the first response and the third response. The second response may be output later than a pair of the first response and the third response that are consecutively output.

According to an embodiment, only a domain of the first intent and a domain of the third intent may correspond to a domain for rearranging an output order of responses.

According to an embodiment, a domain of the first intent and a domain of the third intent may be different from a domain of the second intent. The domain of the first intent and the domain of the third intent may be different or the same.

According to an embodiment, the third response may be output prior to the first response based on a priority.

According to an embodiment, the priority may be determined on an intent-by-intent or domain-by-domain basis.

According to an embodiment, an electronic device 101 may include a processor 120 and a memory 130 storing instructions. When the instructions are executed by the processor 120, the instructions may cause the electronic device 101 to receive a user input. When the instructions are executed by the processor 120, the instructions may cause the electronic device 101 to extract a first intent, a second intent, and a third intent from the user input in order of reception of utterances. When the instructions are executed by the processor 120, the instructions may cause the electronic device 101 to output a first response, a second response, and a third response respectively corresponding to the first intent, the second intent, and the third intent by grouping the response in a different order from the order of reception of utterances based on domain information for rearranging an output order of responses.

According to an embodiment, the domain information may include a combination of one or more of a first domain list for rearranging an output order of responses, a second domain list for preventing an output order of response from being rearranged, and a priority.

According to an embodiment, the first domain list or the second domain list may be based on a usage history of a user, a user response preference, or an attribute of a domain or an association among domains.

According to an embodiment, the priority may be determined on an intent-by-intent or domain-by-domain basis.

According to an embodiment, the instructions may further cause the electronic device 101 to group the first response and the third response into a first group and group the second response into a second group by determining whether domains of the first intent, the second intent, and the third intent are included in the first domain list or the second domain list. According to an embodiment, the instructions may further cause the electronic device 101 to rearrange an order of the first response and the third response in the first group based on the priority.

According to an embodiment, only a domain of the first intent and a domain of the third intent may correspond to a domain for rearranging an output order of responses. According to an embodiment, the second group may be output later than the first group.

According to an embodiment, the third response may be output prior to the first response based on the priority.

According to an embodiment, a method of operating an electronic device 101 may include receiving a user input. The method may include extracting a plurality of intents from the user input in order of reception of utterances. The method may include outputting a plurality of responses corresponding to the plurality of intents in a different order from the order of reception of utterances.

According to an embodiment, an electronic device 101 for processing a response to a user may include a processor 120 and a memory 130 configured to store instructions to be executed by the processor. The processor 120 may generate a text input. The processor 120 may extract a plurality of intents and a plurality of domains from the text input. The processor 120 may generate a plurality of responses corresponding to the plurality of intents. The processor 120 may determine, for the plurality of domains, whether a grouping condition for grouping at least some of the plurality of responses is satisfied. The processor 120 may determine an order of the plurality of responses based on whether the grouping condition is satisfied.

According to an embodiment, the processor 120 may receive the text input from the user. Alternatively, the processor 120 may generate the text input by converting a speech signal received from the user.

According to an embodiment, the processor 120 may extract the plurality of intents and a performance parameter from the text input. The processor 120 may determine the plurality of responses based on the plurality of intents and the performance parameter.

According to an embodiment, the processor 120 may determine whether the grouping condition of the plurality of domains is satisfied based on a predefined context grouping domain.

According to an embodiment, the processor 120 may determine whether the plurality of domains is included in the context grouping domain. The processor 120 may rearrange the order of the plurality of responses corresponding to the plurality of domains based on whether the plurality of domains is included in the context grouping domain.

According to an embodiment, the processor 120 may group responses corresponding to domains, which are included in the context grouping domain, into a first group. The processor 120 may group responses corresponding to domains, which are not included in the context grouping domain, into a second group. The processor 120 may determine an order of the first group and the second group.

According to an embodiment, the processor 120 may generate the context grouping domain based on a usage history of the user, a preference of the user for a response, or attributes of domains or an association among the domains.

According to an embodiment, the processor 120 may exclude some of the plurality of domains based on a domain block list and extract remaining domains. The processor 120 may generate the context grouping domain based on the remaining domains.

According to an embodiment, the processor 120 may assign priorities to the domains, which are included in the context grouping domain. The processor 120 may determine an order of the responses based on the priorities.

According to an embodiment, an electronic device 101 for processing a response to a user may include a processor 120 and a memory 130 configured to store instructions to be executed by the processor. The processor 120 may generate a text input. The processor 120 may extract a plurality of intents and a plurality of domains from the text input. The processor 120 may generate a plurality of responses corresponding to the plurality of intents. The processor 120 may group the plurality of domains based on a predefined context grouping domain. The processor 120 may rearrange an order of the plurality of responses based on the grouped domains.

According to an embodiment, the processor 120 may receive the text input from the user. Alternatively, the processor 120 may generate the text input by converting a speech signal received from the user.

According to an embodiment, the processor 120 may extract the plurality of intents and a performance parameter from the text input. The processor 120 may determine the plurality of responses based on the plurality of intents and the performance parameter.

According to an embodiment, the processor 120 may determine whether a grouping condition of the plurality of domains is satisfied based on the context grouping domain. The processor 120 may group the plurality of domains based on whether the grouping condition is satisfied.

According to an embodiment, the processor 120 may determine whether the plurality of domains is included in the context grouping domain. The processor 120 may rearrange the order of the plurality of responses corresponding to the plurality of domains based on whether the plurality of domains is included in the context grouping domain.

According to an embodiment, the processor 120 may group responses corresponding to domains, which are included in the context grouping domain, into a first group. The processor 120 may group responses corresponding to domains, which are not included in the context grouping domain, into a second group. The processor 120 may determine an order of the first group and the second group.

According to an embodiment, the processor 120 may generate the context grouping domain based on a usage history of the user, a preference of the user for a response, or attributes of domains or an association among the domains.

According to an embodiment, the processor 120 may exclude some of the plurality of domains based on a domain block list and extract remaining domains. The processor 120 may generate the context grouping domain based on the remaining domains.

According to an embodiment, the processor 120 may assign priorities to the domains, which are included in the context grouping domain. The processor 120 may determine an order of the responses based on the priorities.

According to an embodiment, a method of processing a response to a user of an electronic device 101 may include generating a text input. The method may include extracting a plurality of intents and a plurality of domains from the text input. The method may include generating a plurality of responses corresponding to the plurality of intents. The method may include determining, for the plurality of domains, whether a grouping condition for grouping at least some of the plurality of responses is satisfied. The method may include determining an order of the plurality of responses based on whether the grouping condition is satisfied.

The electronic device according to an embodiment disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1^{st},” “2^{nd},” or “first” and “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a processor; and
a memory storing instructions that, when executed by the processor, cause the electronic device to:
receive a user input;
extract a first intent, a second intent, and a third intent from the user input in order of reception of utterances; and
output a first response, a second response, and a third response respectively corresponding to the first intent, the second intent, and the third intent by arranging the responses in a different order from the order of reception of utterances based on respective domains of the first intent, the second intent, and the third intent.

2. The electronic device of claim 1, wherein the instructions further cause the electronic device to:
group the first response and the third response into a first group and group the second response into a second group by determining whether the domains of the first intent, the second intent, and the third intent are comprised in a first domain list or a second domain list, and
wherein the first domain list comprises one or more domains for rearranging an output order of responses, and
wherein the second domain list comprises one or more domains for preventing an output order of responses from being rearranged.

3. The electronic device of claim 2, wherein the instructions further cause the electronic device to:
rearrange an order of the first response and the third response in the first group based on a priority.

4. The electronic device of claim 2, wherein the first domain list or the second domain list is based on a usage history of a user, a user response preference, or an attribute of a domain or an association among domains.

5. The electronic device of claim 1, wherein
the instructions cause the electronic device to consecutively output the first response and the third response, and
the second response is output later than a pair of the first response and the third response that are consecutively output.

6. The electronic device of claim 5, wherein only a domain of the first intent and a domain of the third intent correspond to a domain for rearranging an output order of responses.

7. The electronic device of claim 5, wherein
a domain of the first intent and a domain of the third intent are different from a domain of the second intent, and
the domain of the first intent and the domain of the third intent are different or same.

8. The electronic device of claim 5, wherein the third response is output prior to the first response based on a priority.

9. The electronic device of claim 8, wherein the priority is determined on an intent-by-intent or domain-by-domain basis.

10. An electronic device comprising:
a processor; and
a memory storing instructions that, when executed by the processor, cause the electronic device to:
receive a user input;
extract a first intent, a second intent, and a third intent from the user input in order of reception of utterances; and
output a first response, a second response, and a third response respectively corresponding to the first intent, the second intent, and the third intent by grouping the responses in a different order from the order of reception of utterances based on domain information for rearranging an output order of responses.

11. The electronic device of claim 10, wherein the domain information comprises:
a first domain list for rearranging an output order of responses;
a second domain list for preventing an output order of responses from being rearranged; and
a priority.

12. The electronic device of claim 11, wherein the first domain list or the second domain list is based on a usage history of a user, a user response preference, or an attribute of a domain or an association among domains.

13. The electronic device of claim 11, wherein the priority is determined on an intent-by-intent or domain-by-domain basis.

14. The electronic device of claim 11, wherein the instructions further cause the electronic device to:
group the first response and the third response into a first group and group the second response into a second group by determining whether domains of the first intent, the second intent, and the third intent are comprised in the first domain list or the second domain list.

15. The electronic device of claim 14, wherein the instructions further cause the electronic device to:
rearrange an order of the first response and the third response in the first group based on the priority.

16. The electronic device of claim 14, wherein only a domain of the first intent and a domain of the third intent correspond to a domain for rearranging an output order of responses.

17. The electronic device of claim 14, wherein the second group is output later than the first group.

18. The electronic device of claim 17, wherein the third response is output prior to the first response based on the priority.

19. A method of operating an electronic device, the method comprising:
receiving a user input;
extracting a plurality of intents from the user input in order of reception of utterances; and
outputting a plurality of responses corresponding to the plurality of intents in a different order from the order of reception of utterances.
